(19) United States
(12) Patent Application Publication
(10) Pub. No.: US 2007/0097671 A1
(43) Pub. Date: May 3, 2007

(54) Illuminating Writing Instrument

(76) Inventor: Daniel Walsh, Drakes Branch, VA (US)

Correspondence Address: Moss & Barnett P.A., 4800 Wells Fargo Center, 90 South Seventh Street, Minneapolis, MN, 55402-4129, US

(21) Appl. No.: 11/462,555

(22) Filed: Aug. 4, 2006

Related U.S. Application Data
(60) Provisional application No. 60/705,804, filed on Aug. 4, 2005.

(51) Int. Cl. B43K 29/10; F21V 9/16

(52) U.S. Cl. 362/118; 362/84

(57) ABSTRACT

A writing instrument having a writing cartridge filled with an ink that has fluorescence characteristics such that when it is illuminated by a light it glows. In one embodiment, a substrate is disposed in and dispensable from a housing of the writing instrument. The writing cartridge can be disposed either in the housing or in an adjacent nose cap that contains the light. In another embodiment, the writing cartridge can be disposed in the housing, with or without a substrate. The light can be disposed in a cap or cover detachable to the housing.

### PRIORITY CLAIM

The present application claims the benefit of U.S. provisional application Ser. No. 60/705,804 filed Aug. 4, 2005 and is incorporated herein in its entirety.

### BACKGROUND OF THE INVENTION

1. Field of the Invention

The present invention relates to writing instruments and more particularly to a writing instrument that has an ink that is only capable of being read by light emitted from the writing instrument.

2. Description of the Prior Art

Writing instruments that emit light are known in the art. These instruments have typically utilized cylindrical housings having an electronic bulb or similar light emitting device. These writing instruments tend to be large, bulky and heavy. The size and weight of these writing instruments is directly related to the need for room for the light bulb or diode and the batteries that are used to power the bulbs.

Other writing instruments have been manufactured that utilize an ink that can emit light. The composition of this ink typically includes a chemical such as luminal or the like. The shortcoming of these writing instruments is that after the ink is depleted the pen no longer emits light. What is needed in the writing instrument industry is a writing instrument that is not large, bulky or heavy. What is also needed in the industry is a writing instrument that can emit light with any type of ink, thereby making the writing instrument more versatile.

### SUMMARY OF THE INVENTION

The invention is a writing instrument having a writing cartridge disposed in a housing or barrel that can be gripped by a user during use. The housing is impregnated during manufacturing with a light emitting chemical such as a luminal. The housing will then emit light after charging the luminal impregnated housing with an external light source.

A nose cap can be removably coupled to an end of the housing to secure the ink cartridge for writing. The nose cap can be manufactured from a clear material to allow light emitted from the housing to illuminate a paper or other substrate during writing. In another embodiment, the nose cap can be impregnated with a light emitting chemical such as luminal.

A nose cap cover assembly can be removably coupled to and over the nose cap to provide a means of charging the light emitting housing and/or nose cap cover. The nose cap cover assembly can comprise a light emitting device connected to a power supply and/or switch.

An end cap can be coupled to an end of the housing opposite the nose cap. The end cap is utilized to secure a free end of the ink cartridge in the housing. The end cap can be manufactured from a clear material or a material impregnated with a light emitting chemical.

A reflective end cover can be disposed over the end cap to reflect light down through the housing and/or nose cap and onto paper or other substrate during writing.

An object of the invention is to provide a lighted writing instrument that is easily manufactured and used.

Another objection of the invention is to provide an ink cartridge containing invisible ink that is illuminated by the light emitted from the housing.

Still another object of the invention is that it eliminates the need of an internal light source and power supply.

Still yet another advantage of the invention is that it illuminates a substrate while it is used for writing.

Yet another advantage of the invention is that it can be repeatedly used with any type of ink refill cartridge.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded view of a light emitting writing instrument according to an example embodiment of the present invention.

FIG. 2 is an exploded view of the nose cap cover assembly according to an example embodiment of the present invention.

FIG. 3A is a perspective view of an end cover of the nose cap cover assembly according to an example embodiment of the present invention.

FIG. 3B is a perspective view of the end cover illustrated in FIG. 3A showing an interior thereof.

FIG. 3C is cross section view of the end cover of FIGS. 3A and 3B.

FIG. 3D is an end view of the end cover of FIGS. 3A-3C.

FIG. 4A is a perspective view of an actuator according to an example embodiment of the present invention.

FIG. 4B is a side view of the actuator of FIG. 4A.

FIG. 5A is a perspective view of a power supply.

FIG. 5B is an end view of the power supply of FIG. 5A.

FIG. 5C is an opposite end view of the power supply of FIG. 5C.

FIG. 6A is a perspective view of a light emitting member according to an example embodiment of the invention.

FIG. 6B is a side view of the light emitting member of FIG. 6A.

FIG. 6C is an end view of the light emitting member of FIG. 6A.

FIG. 7A is a perspective view of a nose cap cover according to an example embodiment of the present invention.

FIG. 7B is a cross section view of the nose cap cover of FIG. 7A.

FIG. 7C is an end view of the nose cap cover of FIG. 7A.

FIG. 8A is a perspective view of a nose cap according to an example embodiment of the invention.

FIG. 8B is a cross section view of the nose cap of FIG. 8A.

FIG. 8C is an end view of the nose cap of FIG. 8A.

FIG. 8D is a perspective view of the nose cap of FIG. 8A illustrating an aperture through which the ink cartridge is disposed.

FIG. 9A is a perspective view of the housing according to an example embodiment of the invention.

FIG. 9B is a cross section view of the housing of FIG. 9A.

FIG. 9C is an end view of the housing of FIG. 9A.

FIG. 10A is an exploded perspective view of an end cap assembly comprising an outer end cap and an inner end cap according to an example embodiment of the present invention.

FIG. 10B is a cross section view of the outer end cap of FIG. 10A.

FIG. 10C is an end view of the outer end cap of FIG. 10A.

FIG. 10D is a cross section of the inner end cap of FIG. 10A.

FIG. 10E is an end view of the inner end cap of FIG. 10A.

FIG. 11A is an enlarged view of an end of the outer end cap showing a coupling assembly.

FIG. 11B is a top view of the coupling assembly of FIG. 11A.

FIG. 12A is a perspective view of a reflective member according to an example embodiment of the invention.

FIG. 12B is a side view of the reflective member of FIG. 12A.

FIG. 12C is an end view of the reflective member of FIG. 12A.

FIG. 13A is a perspective view of a light emitting writing instrument having a light disposed in a nose cap thereof.

FIG. 13B is a partial exploded view of an illuminating mechanism disposed in the nose case of FIG. 13A.

FIG. 14A is a perspective view of a light emitting writing instrument having at least one light emitting member extending along a length of the instrument.

FIG. 14B is a partial exploded view of an illuminating mechanism disposed to the instrument of FIG. 14A.

FIG. 14C is a cross section view of a tip of the illuminating writing instrument having a reflective interior.

FIG. 15A is a side view of an illuminating writing instrument having a plurality of illuminating strands.

FIG. 15B is a side view of an illuminating writing instrument having a plurality of illuminating strands and at least one illuminating strand extending generally a length of the instrument.

FIG. 15C is a side view of the illuminating mechanism disposed in FIG. 15A.

FIG. 16 is a perspective view of the illuminating writing instrument having a substrate dispenser.

The preceding description of the drawings is provided for example purposes only and should not be considered limiting. The following detailed description is provided for more detailed examples of the present invention. Other embodiments not disclosed or directly discussed are also considered to be within the scope and spirit of the present invention.

### DESCRIPTION OF THE PREFERRED EMBODIMENT

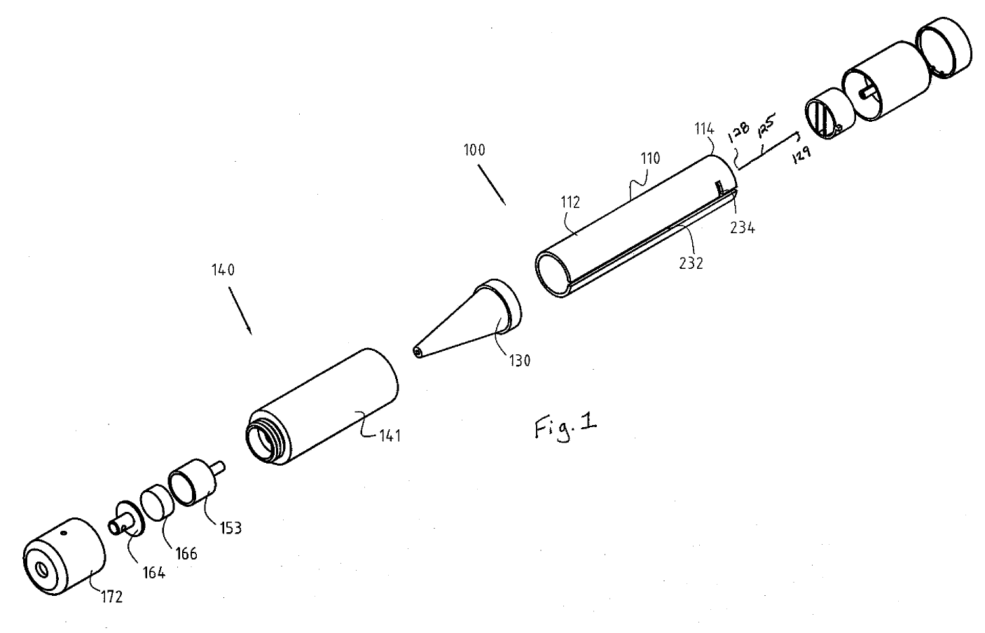

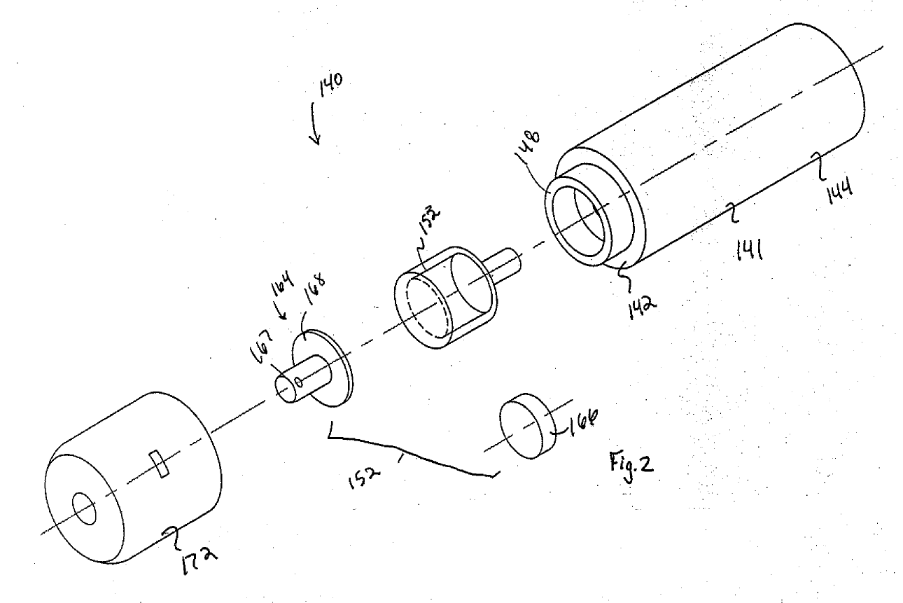

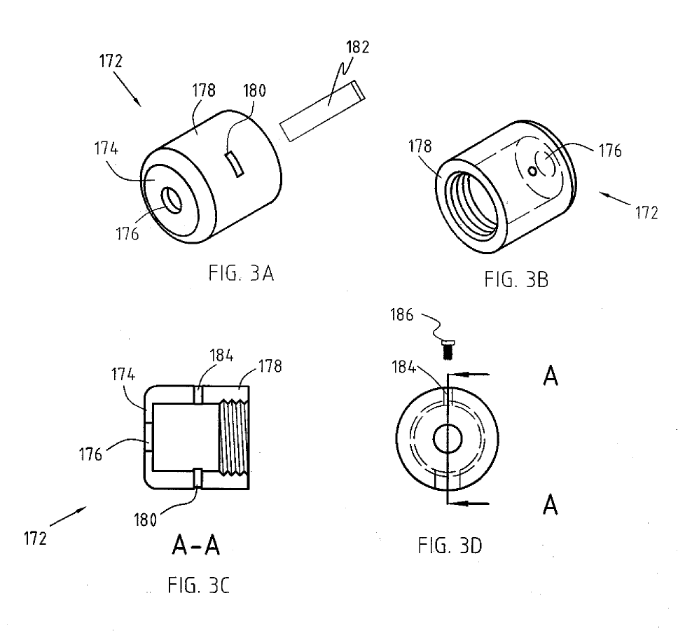

Referring to FIGS. 1-16 a light emitting writing instrument such as a pen, ballpoint pen, fountain pen, pencil, marker, highlighter and the like, is indicated by the number 100. Writing instrument 100 includes a housing, barrel, or pen tube 110 having an open first end 112 and an open second end 114 in registration with each other.

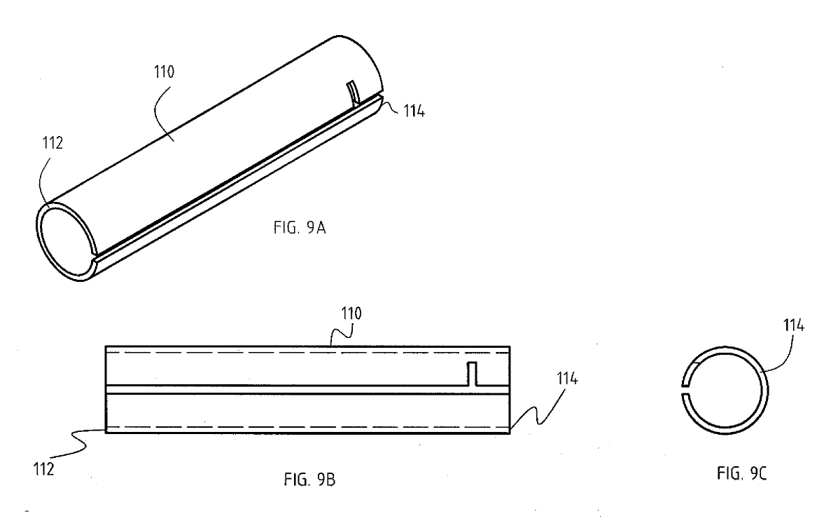

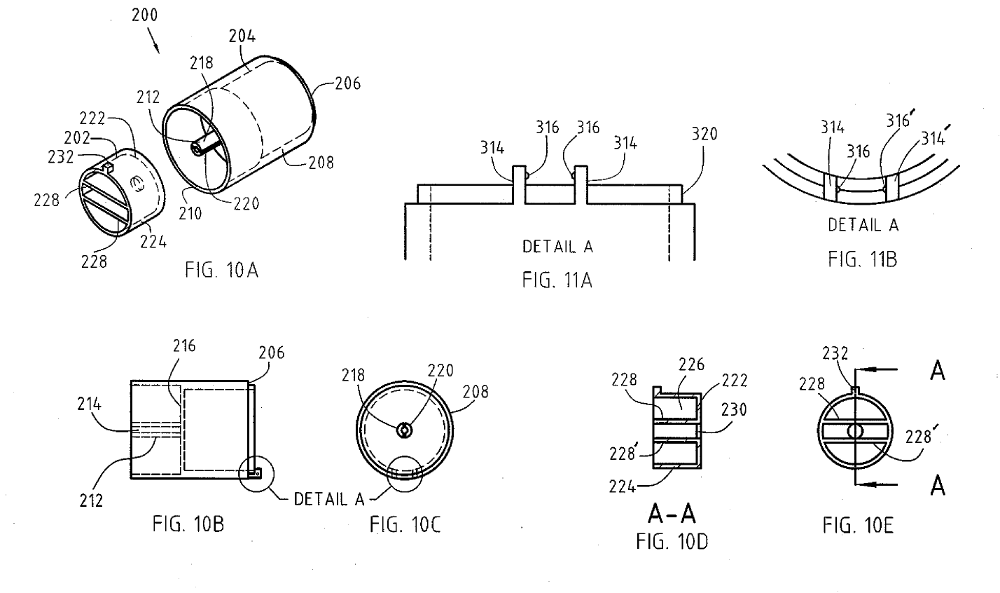

Referring to FIGS. 1 and 9A-9C, in a preferred embodiment, housing 110 is manufactured from a polymer such as polypropylene, polyethylene and the like. During the manufacturing process, the material is impregnated with a chemical having the properties of at least temporarily storing and emitting light. One such chemical having these known properties is luminol. Once impregnated with luminol or similar chemical, housing 110 will be able to emit a light when it is exposed to light having a wavelength generally between 180 and 400 nanometers. In another embodiment, the chemical impregnated housing is capable of absorbing the energy from the light and emits it as its own light.

Housing 110 can be manufactured with any color, design or lettering printed on its outer surface for advertising of a particular trademark, logo, or brand so long as it does not interfere with the light emitting property of housing 110. This is of particular importance if the writing instrument is utilized as a marketing tool since vivid colors, designs, and lettering typically attract a user's eyes and others toward the writing instrument.

To ensure that housing 110 is comfortable to use it may have a generally cylindrical shape. However, housing 110 may have any cross sectional shape such as, for example triangular, square, oval, and the like. An outer surface of housing 110 may be coated and/or ribbed to increase tactile feel and improve comfort. A compressible sleeve (not shown) can be slid over housing 110 to provide additional comfort for a user.

Referring back to FIG. 1, an ink, marker or similar writing cartridge 125 is removably disposed within housing 110. Writing cartridge 125 has a first writing end 128 that is disposed proximate open first end 112 of housing 110 and second securing end 129 proximate open second end 114 of housing 110. Writing cartridge 125 preferably dispenses an invisible ink that can only be read when illuminated with the light emitted from housing 110. This permits a children or users to write secret messages to each other.

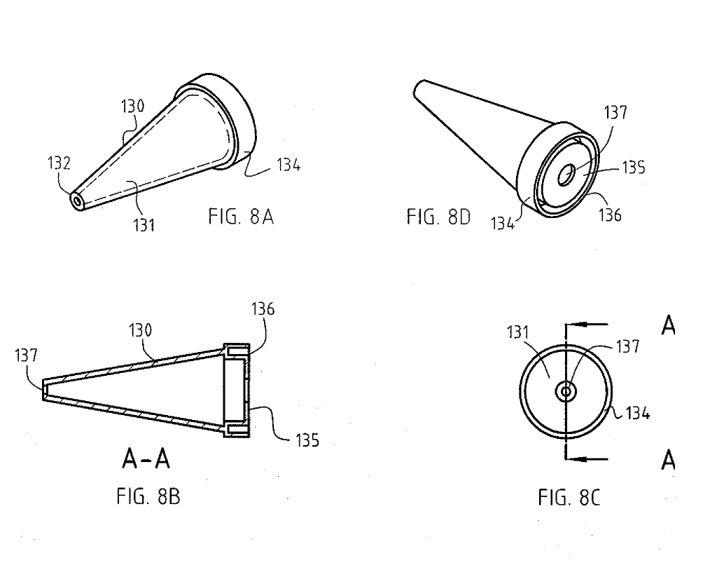

Referring to FIGS. 1, and 8A-8D, a nose cap 130 can be removably disposed over open first end 112 of housing 110 to provide support to writing cartridge 125. Referring particularly to FIGS. 8A-8D, nose cap 130 is comprised of a generally conical housing 131 having a generally conical tip portion 132 and a generally annular collar portion 134 having an outer diameter generally greater than an outer diameter of tip portion 132. As particularly illustrated in FIGS. 8B-8D, nose cap 130 has a lower or bottom wall 135 for supporting ink cartridge 125 when disposed in housing 110. An annular channel 136 extends into annular collar portion 134 and about bottom wall 135 for receiving open first end 112 of housing 110.

In one example embodiment, nose cap 130 can be threadedly coupled to housing 110. In another example embodiment, nose cap 130 can be pressure fitted to housing 110. When nose cap 130 is disposed on housing 110 first writing end 128 of writing cartridge 125 extends through holes 137 and 137 extending through tip portion 132 and bottom wall 135 respectively (see FIGS. 8B and 8D).

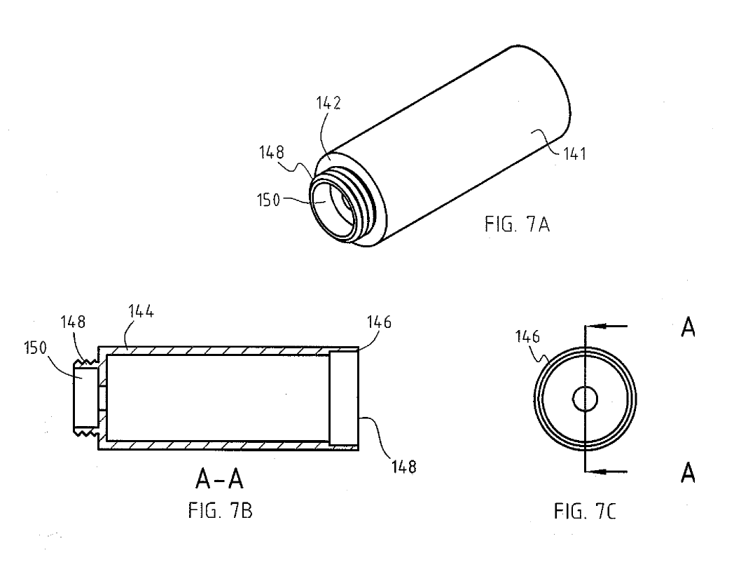

Referring to FIGS. 1 and 2-7C, a nose cap cover assembly 140 can be provided to prevent first writing end 128 of writing cartridge 125 from drying out. Nose cap cover assembly 140 can also be used to charge the light emitting chemical impregnated into housing 110. To this extent, nose cap cover assembly 140 can comprise a nose cap cover 141 having a top or upper wall 142 and a peripheral wall 144 extending away therefrom. Referring to FIGS. 7A-7C, peripheral wall 144 has an edge 146 defining an access opening 148 for receiving nose cap 130. Nose cap cover 141 can comprise any generally rigid material such as plastic, wood, metal or the like. In one example embodiment, nose cap cover 141 can be impregnated with a light emitting chemical such as luminol such that upon charging it will emit light.

In one example embodiment, nose cap cover 141 can also include a collar 148 extending away from wall 142 defining an opening 150 for receiving a light charging subassembly 152 such as a light emitting diode (LED), light bulb, and a switch. As illustrated in FIGS. 2 and 6A-6C, light charging subassembly 152 can comprise a housing 153 having a power housing portion 154 having a peripheral wall 156 and a bottom wall 158 defining an interior 160. The housing 152 also comprises a light housing portion 162 extending down from bottom wall 158 for storing a light source capable of emitting light.

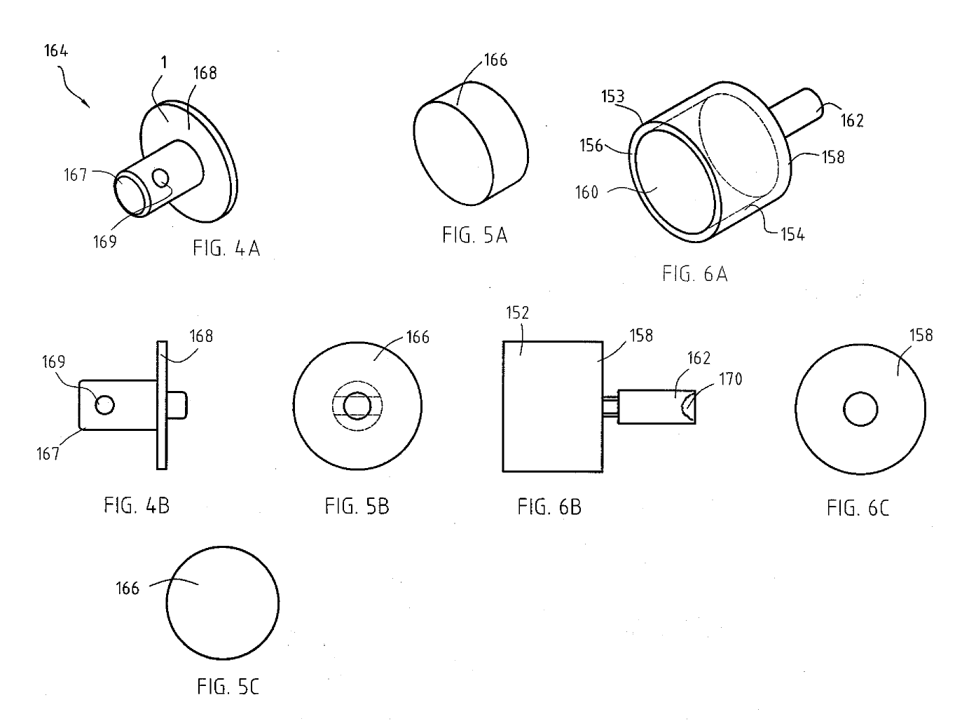

Referring to FIGS. 4A-5C, an actuator 164 and a power supply 166 are operatively disposed in interior 160 of power housing portion 154. Actuator 164 can comprise a push-button switch 167 operatively disposed on a coupling plate 168 that comes into selective contact with power supply 166. An aperture 169 can be formed in push-button switch 167 for receiving a tether or lancet. A user can place the tether over around their neck for storage and during transportation of writing instrument 100.

Power supply 166 can comprise at least one watch battery that is in operative communication with a light 170 disposed in the light housing potion 162 of housing 153. Multiple batteries can also be utilized to extend the length of charging.

The light 170 disposed in light housing portion 162 can comprise a light emitting diode, light bulb, or the like. In another example embodiment of the invention, light housing portion 162 is omitted and light 170 is disposed directly to power housing portion 154. Other configurations are also possible and would be readily discernable to one skilled in the art after being taught the herein described invention. Therefore, slight modifications and arrangements should be considered to be within the spirit and scope of the invention.

Referring to FIGS. 1, 2 and 3A-3D, a cover 172 is removably coupled to nose cap cover 141 for at least temporarily securing light charging subassembly 152 in nose cap cover 141. In one example embodiment, cover 172 comprises a top wall 174 having a centrally disposed opening 176 extending therethrough for receiving actuator 164 when it is disposed on nose cap covet 141. A peripheral wall 178 extends from top wall 174 of cover 172 for securing to collar 148 of nose cap cover 141. An inner surface of peripheral wall 178 may be threaded for threaded engagement with a threaded outer surface of collar 148. In another embodiment, cover 172 is pressure fitted or coupled to collar 148 of nose cap cover 141.

Peripheral wall 178 of cover 172 can include at least one slot 180 extending therethrough for receiving a tab or other substrate that separates power supply 166 from light 170. Tab 182 can extend through slot 180 and through an opening in power housing portion 154 to separate power supply 166 and light 170. Upon retracting or pulling tab 182 out of slot 180 writing instrument 100 becomes functional. Tab 182 can also be disposed between actuator 164 and power supply 166. Other arrangements are also possible and should be considered to be within the spirit and scope of the invention.

Peripheral wall 178 can also include a fastener opening 184 extending therethrough for receiving a fastener 186 that is used to secure light charging subassembly 152 in cover 172. Fastener 186 can comprise any conventional fastener such as a metal screw, wood screw, pin, or any other fastener known to one skilled in the art.

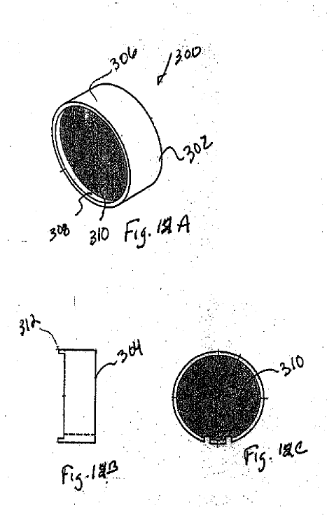

Referring now to FIGS. 1 and 10A-10E, at least one end cap assembly 200 is detachably couplable to the open second end 114 of housing 110 for holding the second end 129 of writing cartridge 125. In one embodiment, end cap assembly 200 comprises an inner end cap 202 and an outer end cap 204. The outer end cap 204 can include a top wall 206 having a peripheral wall 208 extending away therefrom that defines an access opening 210 for receiving open second end 114 of housing 110.

Outer end cap 204 includes a post 212 having a bore 214 extending longitudinally therein for receiving and at least temporarily securing cartridge 125. Post 212 is centrally disposed on and extends from an intermediate wall 216 disposed in outer end cap 204. In another example embodiment, as particularly illustrated in FIG. 7C, post 212 is divided along its longitudinal axis defining first 218 and second 220 post portions that extend away from each other when writing cartridge 125 is inserted in bore 214. In this embodiment, an inner diameter of bore 214 is at least slightly smaller than an outer diameter of writing cartridge 125 to create a friction fit therebetween.

Inner end cap 202 is operatively coupled between housing 110 and outer end cap 204 to secure outer end cap 204 to housing 110. In an example embodiment, inner end cap 202 has a top wall 222 and a peripheral wall 224 extending away therefrom forming an interior space 226. A pair of supports 228 and 228′ can be disposed in and extend generally across the interior space 226. Supports 228 and 228′ can comprise plates or panels having a length generally equal to a length of peripheral wall 194.

Top wall 222 of inner end cap 202 has a generally centrally disposed aperture 230 extending therethrough for receiving post 212. In an example embodiment, post 212 is disposed generally between supports 228 and 228′. Inner end cap 202 can be secured in outer end cap 204 by an adhesive or other mechanical means such as by threaded engagement.

Inner end cap 202 can also include a tab 232 extending away from an outer surface of its peripheral wall 224 for operatively engaging and securing inner end cap 202 and outer end cap 204 to housing 110. In an example embodiment, as illustrated in FIGS. 1, tab 232 can operatively engage a slit 234 and a notch 236 extending transversely therefrom into housing 110. To secure inner end cap 202 to housing 110, tab 232 is inserted and slid within slot 232. Tab 232 becomes aligned with notch 234. Rotation of inner end cap 204 forces tab 232 into notch 234 such that it extends transversely through notch 234 thereby preventing its disengagement from housing 110. Other means of engaging inner end cap 203 to housing 110 are also contemplated by the invention, for example threaded engagement, pressure fitting, and snap fitting.

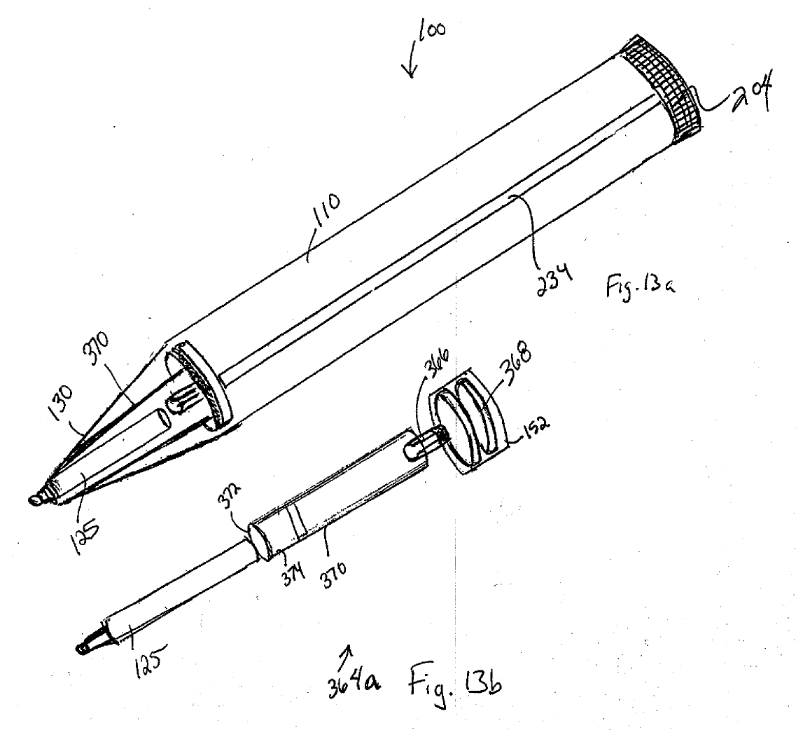

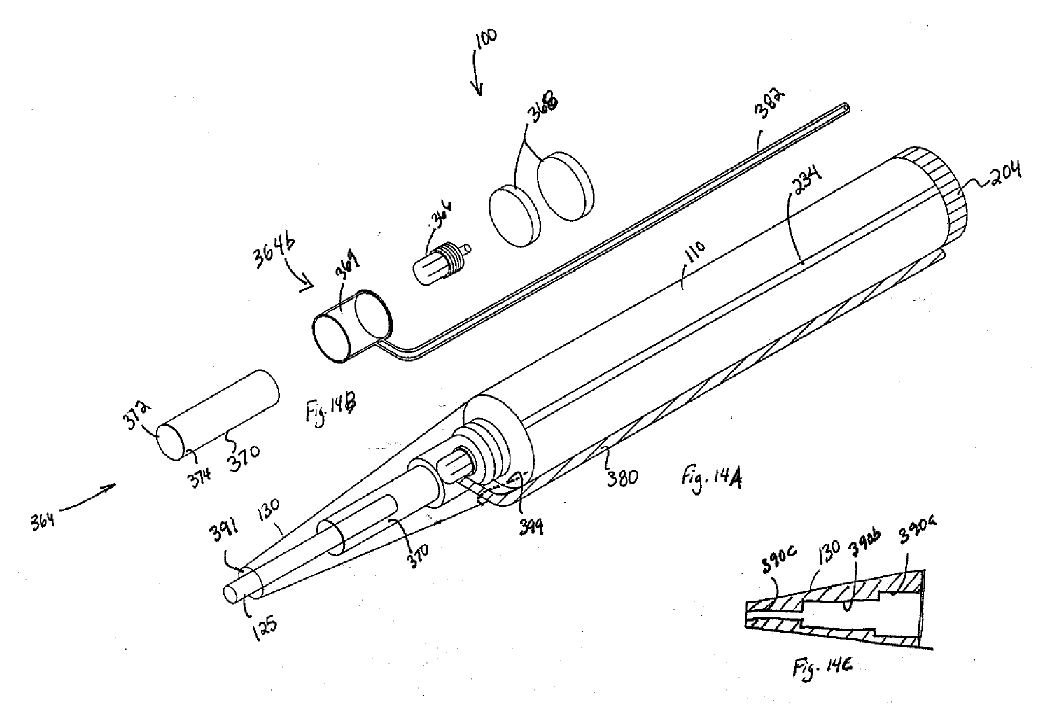

Referring to FIGS. 11A-12C, a reflective member 300 can be coupled to outer end cap 204 to reflect light back down into housing 110 and out nose cap 130. Reflective member 300 can comprise a housing 302 having a top wall 304 and a peripheral wall 306 defining an interior 308 thereof. A reflective mirror 310 can be disposed in the interior 308. In an alternate embodiment, an inner surface of top wall 304 can be polished to create a reflective surface, thereby eliminating the need for a mirror.

As illustrated in FIG. 12B, a lip 312 can extend beyond the mirror. Lip 312 can be used to operatively couple reflective member 300 to outer end cap 204. As illustrated in FIG. 11A a pair of prongs 314 and 314′ can extend from top wall 206 of outer end cap 204. Each of prongs 314 and 314′ includes a protrusion 316 and 316′ respectively that can engage a portion of reflectively member 300. As illustrated in FIG. 12C, housing 302 of reflective member 300 can include a pair of slots 318 and 318′ for receiving prongs 314 and 314′ respectively. An inner surface of slots 318 and 318′ can include depressions for receiving protrusions 316 and 316′. In this particular embodiment, reflective member 300 is hingedly coupled to outer end cap 204. Reflective member 300 can also be threadedly coupled, pressure fitted, or snapped on outer end cap 204. Other forms of engagement are also contemplated and should be considered to be within the spirit and scope of the invention.

As illustrated in FIG. 11A, a shoulder 320 can be formed on top wall 206 of outer end cap 204 for receiving reflective member 300. When coupled together, lip 312 of reflective member 300 surrounds shoulder 320 of outer end cap 204.

After purchase, a user removes tab 182 and illuminates light 170 by depressing or switching actuator 164. During illumination, the light emitting chemical impregnated in housing 110 charges. The user may then remove light charging assembly 140 to expose ink cartridge 125. Upon writing a message on a substrate, a user notices that no ink has apparently been disposed on the substrate. Once the light in the room or surroundings are extinguished, housing 110 emits a specialized light that illuminates the written message.

In another embodiment, a user can write a message in reverse with the invisible ink contained in the ink cartridge 125. Another user can then use reflective member 300 and the light emitted from housing 110 to read the reversed message.

In yet another embodiment of the invention, housing 110 can be impregnated with a light emitting chemical that emits visible light in the dark. This permits writing instrument 100 to be used as a wand to write message in the air that can be read by their friends. Once housing 110 no longer emits light, a user can recharge writing instrument 100 by using light charging assembly 152 or holding housing 110 under a lamp or other light source.

Referring to FIGS. 13A and B, a light assembly 364a is shown inside and out of the nose cap 130 of FIG. 13. In this embodiment, the writing cartridge 125 is disposed in nose cap 130 along with a light emitting member 366, power supply 368 and an enclosure 370. Writing cartridge 125 can be threaded into nose cap 130 or pressure fitted to secure and reinforce it for writing and replacement. As described above, the light emitting member 366 can comprise a UV light or any other light emitting device capable of illuminating an ink or other fluid in the writing cartridge 125 containing a chemical such as luminol or any chemical capable of fluorescence, photoluminescence, phosphorescence and the like. The light may comprise a light bulb, light emitting diode or the like.

The enclosure 370 encloses or encases the writing cartridge 125 and light emitting member 366. In one embodiment, it may comprise a cylindrical tube having an inner surface 372 and an outer surface 373. The inner surface 372 can have a reflective coating such that light emitted from the light member 366 can be reflected back toward writing cartridge 125 having a clear case to illuminate or charge the chemical contained therein. When the chemical in the writing cartridge 125 is illuminated with light emitting member 366 it will glow as a user writes on paper or any other substrate. After a period of time the light will fade making what was written invisible. Upon exposing the writing to a light, such as a UV light the writing will again illuminate or glowing making reading it possible.

In one embodiment, the enclosure 370 can be a filter adapted to filter out harmful wavelengths of light emitted from the light emitting member 366. In another embodiment, a filter 376 can be disposed in the enclosure 370 to filter any light that may escape from the nose cap 130. In another embodiment, the nose cap 130 may be a filter capable of filtering out harmful or undesired wavelengths from escaping therefrom.

To actuate the light emitting member 366, a user can depress an actuator that is operatively coupled to the light emitting member 366 and power supply 368. The actuator can be a push-button switch mounted on the housing 110 or the nose cap 130. In another embodiment, a user begins writing which in turns causes the writing cartridge 125 to be depressed and engage the light emitting member 366. The light emitting member 366 then engages a biased pair of batteries that come into contact with each other, thereby completing a circuit and illuminating the light emitting member 366.

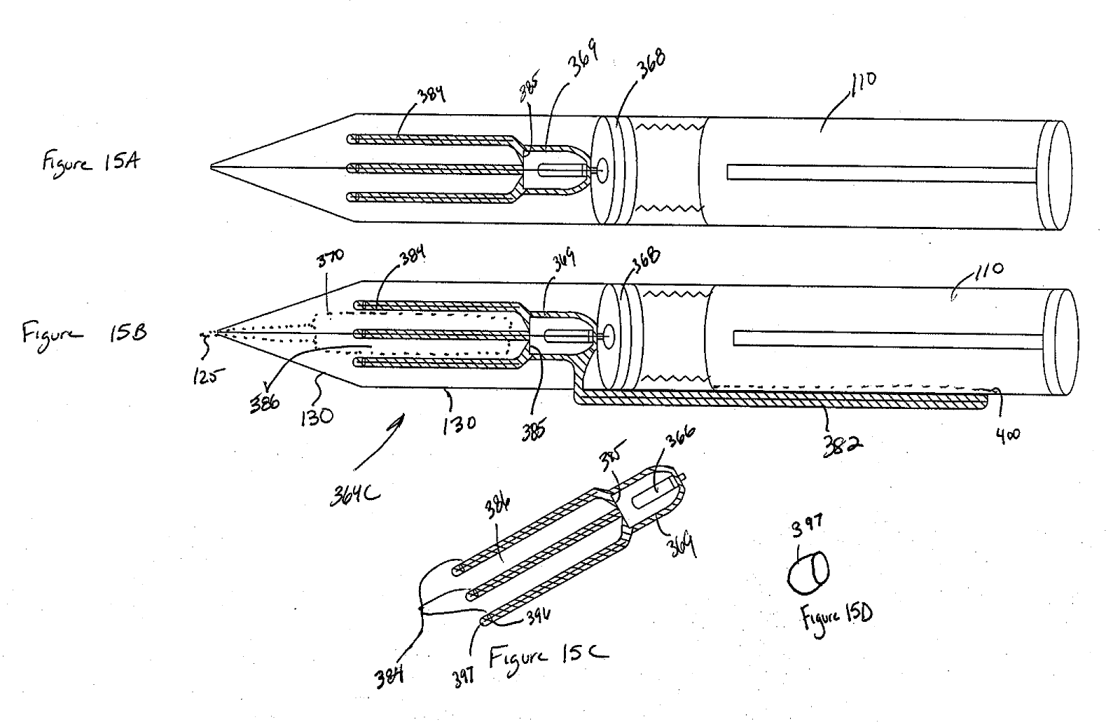

Referring to FIGS. 14A-14C, the light assembly 364b includes a second light emitting member or optic strand 380 that can be disposed to the housing 110 to illuminate a message which has exhausted its illumination. The second light emitting member 380 can comprise a fiber optic strand 382 capable of channeling or directing light emitted from the light emitting member 366 along a side of the housing 110. The fiber optic strand 382 is capable of either illuminating the writing or charging the writing such that it will illuminate on its own for a period of time. The fiber optic strand 382 can have any length and is preferably operatively connected to or proximate to the power supply 368. The strand 382 can be connected to or integral with a collar 369 that fits over the light emitting member 366. The collar 369 is preferably made from the same material as the strand 382 such that light emitted by the light emitting member 366 is captured by the collar 369 and transmitted through the strand 368.

The collar 369 can include a size and shape to receive the enclosure 370 which can in turn receive the writing cartridge 125. This interconnection of components permits most of the light emitted from the light emitting member 366 to be directed to the writing instrument 125 and the strand 382. The interconnection of the components can be accomplished by pressure fitting, threading or any other mechanism that will allow a user to connect and disconnect the components as needed.

Referring to FIG. 14C, the nose cap 130 of the illuminating writing instrument 100 can have a plurality of successionally narrower bores 390a-390c extending from the housing 110 to a tip 391 of the nose cap 130. The narrowing of the bores 390a-390c permits reinforcement of the collar 369, enclosure 370 and the writing cartridge 125 when they are interconnected and disposed within the nose cap 130. An inner surface of the nose cap 130 can be mirrored or reflective to reduce the amount of light that can escape out of the tip 391 of the nose cap 130. In another embodiment of the invention, the nose cap 130 can comprise any material that would permit the nose cap 130 to act as a filter by absorbing light emitted from the light emitting member 366.

The strand 382 can be connected to the housing 110 by any means. In one embodiment, the strand 382 can be disposed into a channel extending along a long axis of the housing 110. In this embodiment, the strand 382 snaps into the channel such that it can be disconnected from the housing 110 if the light emitting member 366, power supply 368 and/or writing cartridge 125 needs to be replaced. In another embodiment, the strand 382 can be connected to the housing 110 by an adhesive or by a mechanical means such as a strap.

In one embodiment of the invention, the nose cap 130 can include a notch 392 extending from a point where it connects to the housing 110 generally toward the tip 391 thereof to permit nesting with or receiving of the strand 382 extending away from the collar 369. It is also possible that the strand 382 extends away from the collar 369 and extends through a portion of the housing 110 such that the nose cap 130 does not interfere with the strand 382 when it is connected to the housing 110.

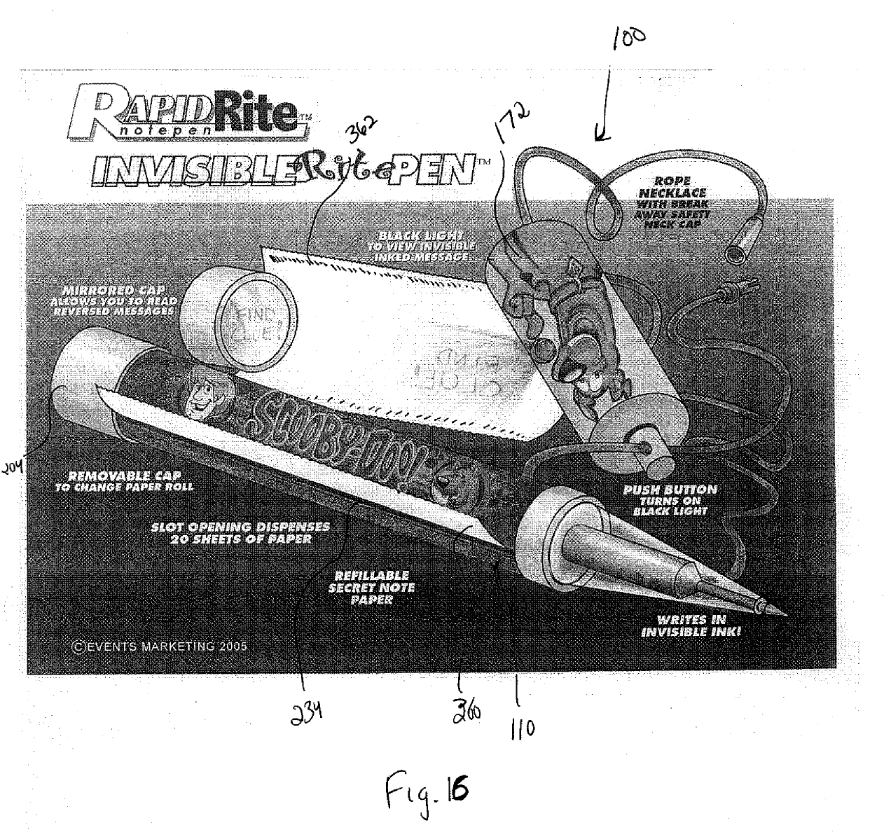

Referring to FIGS. 15A-15C, the light assembly 364c can include a collar 369 that is modified to include a plurality of light emitting segments 384 that generally extend away from a top portion 395 of the collar 385. In this embodiment, the light emitting segments 384 can be oriented to form a cavity or area 385 that can receive the enclosure 370 and the writing cartridge 125. The cavity 385 can be formed such that the light emitting segments 384 and enclosure 370 forms a snug or pressure fit together. This is done to provide stability to the components when connected.

Referring to FIGS. 15C and 15D, each of the light emitting segments can include a free end 396 that is formed by folding the light emitting segment 384 back onto itself. The free ends 396 can be covered by an end cap 397 that can have a reflective or mirrored inner surface to reflect the flight back into the light emitting segment 384. This is done to redirect the emitted light onto the writing cartridge 125 for recharging.

As particularly illustrated back in FIG. 15B, a strand 382 can be attached to and extend away from the collar 369 to illuminate an area away from or generally proximate to the housing 110. As discussed above, the strand 382 permits a user to read a message that is already written and which may have lost its ability to illuminate. The strand 382 can be connected to the housing 110 as described above. In this, and in fact any of the embodiments, the housing 110 can include at least a portion thereof that is mirrored or has a reflective outer surface. This permits the housing 110 to reflect light emitted by the strand 382 away from the housing 110 and onto a surface such as a substrate. In one of the preferred embodiments, the mirrored or reflective portion of the housing 110 is disposed in the groove 400 formed in the side of the housing 110.

As particularly illustrated in FIG. 15C, the collar 369 can encapsulate the light emitting member 366 with a terminal of the light emitting member 366 extending through a portion of the collar 369. In other embodiments, the collar 369 and the light emitting member 366 can be spaced apart from each other to easily permit disconnection of the components such as the light emitting member 366, the enclosure 370 and the writing cartridge 125.

The light emitting segments 384 and the strand 382 of this particular embodiment can comprise encapsulated (spun glass) fiber optic. Other types of fiber optics are also possible and should be considered to be within the spirit and scope of the invention.

Continuing with FIGS. 15A and 15B, the power supply 368 can be disposed in the housing 110 or the nose cap 130 and is operatively coupled to the light emitting member 366. In one embodiment, the power supply 368 can be inserted into a side of the nose cap 130 or housing 110 such that it comes into contact with the terminal of the light emitting member 366. A door or other securing mechanism can be operatively coupled to the nose cap 130 or housing 110 to secure the power supply 368 therein. The door or other securing mechanism can be connected by hinges, slide rails and the like.

Referring now to FIGS. 16, a substrate 360 can be disposed in the housing 110 and can be dispensed by a user to write upon with the writing cartridge 125. The applicant of the present invention received U.S. Pat. No. 6,247,864 for a paper dispensing note pen which is incorporated herein in its entirety. In one embodiment, the substrate 360 is a roll of paper having perforations such that it can be torn or separated at predetermined locations on the roll. The roll does not need to be connected to any mechanism within the housing. An end of the substrate 360 can extend through slit 234 in housing 110 which can include a plurality of teeth or serrations to assist in separating a piece of the substrate 360 from the roll. In this embodiment, the inner end cap 202 of FIG. 10A may or may not be used. The outer end cap 204 can be used by itself or in conjunction with the inner end cap 202.

The substrate 360 has a rear surface that can have an adhesive 362 disposed thereon such that the substrate 360 at least temporarily adheres to a surface. In one embodiment, the adhesive 362 is disposed proximate at least two opposed edges to prevent the substrate 360 from coiling when adhered to a surface. In another embodiment, the adhesive 362 can cover substantially the entire rear surface of the substrate 360. The adhesive 362 may comprise a type known in the art that permits the re-adhering of substrates to surfaces.

Numerous modifications are also contemplated in the present invention. For example, all parts of writing instrument 100 can be manufactured from a single material or they may comprise any combination of various materials. Advertising, logos, designs and other indicia can be imprinted or imparted on any component of writing instrument 100 including, but not limited to, housing 110, nose cap 130, cover 160, nose cap cover 140, and/or end cap 170.

The present invention may be embodied in these and other specific forms without departing from the, spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A light emitting writing instrument comprising:
a housing having an interior;
a writing cartridge being operatively coupled with the housing, the writing cartridge having a fluid that fluoresces when exposed to UV light;
a cap being removably attached to the housing;
a UV light disposed in the cap to illuminate an area adjacent to the cap;
a power supply disposed in the cap to supply power to the UV light; and
an actuator operatively coupled to the cap and in communication with the UV light and power supply.

2. The light emitting writing instrument of claim 1, further comprising a substrate disposed in the interior of the housing, wherein a user can remove at least a portion of the housing to write upon with the fluid in the writing cartridge.

3. The light emitting writing instrument of claim 2, further comprising an adhesive being disposed proximate at least two opposed edges of the substrate such that it prevents it from coiling when the substrate is removably affixed to a surface.

4. The light emitting writing instrument of claim 2, further comprising an adhesive being disposed on and covering substantially all of a surface of the substrate.

5. The light emitting writing instrument of claim 1, further comprising a nose cap disposed over at least a portion of the writing cartridge.

6. The light emitting writing instrument of claim 1, wherein the UV light is encapsulated within the cap such that there is at least restricted access to the UV light.

7. The light emitting writing instrument of claim 1, further comprising a filter disposed proximate the UV light to block predetermined wavelengths of light.

8. The light emitting writing instrument of claim 1, further comprising a lanyard removably attached to the cap, wherein a user can hang the light emitting writing instrument.

9. The light emitting writing instrument of claim 1, further comprising an end cap removable from the housing, the end cap having a generally reflective inner surface.

10. The light emitting writing instrument of claim 9, further comprising an inner end cap disposed between the housing and the end cap to secure a substrate dispensably disposed in the housing.

11. The light emitting writing instrument of claim 1, wherein the housing is manufactured from a material impregnated with a chemical capable of emitting light.

12. A light emitting writing instrument comprising:
a housing having an interior,
a substrate being disposed in the interior and extendable through an opening extending into the housing, wherein a user can remove at least a portion of the substrate to write upon;
a nose cap being disposed to an end of the housing;
a writing cartridge removably disposed in and extendable from the nose cap to permit a user to write upon the substrate;
an ink disposed in the writing cartridge having a fluorescence characteristic such that it illuminates when exposed to a light;
a light disposed proximate to the nose cap such that it illuminates at least a portion of the writing cartridge and ink;
a power supply disposed in the nose cap; and
an actuator disposed in the nose cap, the actuator being in operative communication with the power supply and light.

13. The light emitting writing instrument of claim 11, wherein the substrate has a rear surface having an adhesive disposed over at least a portion thereof that permits the substrate to removably stick to a surface without coiling.

14. The light emitting writing instrument of claim 12, further comprising a light assembly disposed proximate to the light to transport and emit the light over a distance.

15. The light emitting instrument of claim 14, wherein the light assembly includes an enclosure having a reflective interior that can receive the light and the writing cartridge.

16. The light emitting instrument of claim 14, wherein the light assembly includes a collar having at least one light emitting segment extending away therefrom.

17. The light emitting instrument of claim 16, further comprising a strand in operative communication with the collar, the strand extending a distance outside of the housing.

18. The light emitting writing instrument of claim 15, wherein the nose cap includes an interior having successively narrower bores to receive and stabilize the enclosure and writing cartridge.

19. The light emitting writing instrument of claim 12, wherein the light comprises a UV light bulb.

20. The light emitting writing instrument of claim 12, wherein the light comprises a UV light emitting diode.

21. The light emitting writing instrument of claim 14, wherein the light assembly is at least partially encased by a filter that filters a predetermined wavelength of light.

22. A light emitting writing instrument comprising:
a housing having an interior;
a writing cartridge being operatively coupled with the housing, the writing cartridge having a fluid that fluoresces when exposed to UV light;
a cap being removably attached to the housing;
a first UV light disposed in the cap to illuminate an area adjacent to the cap;
a second UV light disposed in the nose cap to illuminate an area adjacent the housing;
a power supply disposed in the cap and the housing to supply power to the first and second UV light; and
an actuator operatively coupled to the cap and the housing and in communication with the first and second UV lights and power supply.
